(19) United States
(12) Patent Application Publication
(10) Pub. No.: US 2012/0138260 A1
(43) Pub. Date: Jun. 7, 2012

(54) HIGH VOLTAGE BATTERY COOLING SYSTEM FOR A VEHICLE

(75) Inventor: Gun-Goo Lee, Suwon (KR)

(73) Assignees: KIA MOTORS CORPORATION, Seoul (KR); HYUNDAI MOTOR COMPANY, Seoul (KR)

(21) Appl. No.: 13/173,650

(22) Filed: Jun. 30, 2011

(30) Foreign Application Priority Data
Dec. 3, 2010 (KR) 10-2010-0123051

(51) Int. Cl. B60H 1/32

(52) U.S. Cl. 165/41

(57) ABSTRACT

The present invention provides a system for cooling a high voltage battery by emitting cooling air from an outlet duct to the interior of a vehicle. More specifically, a battery case is mounted on/within an underfloor area formed within a lower section which extends from a front seat to a back seat. In order to collect air to cool the battery module, an inlet duct is disposed at the front end of the battery case and draws the cooling air from the interior of the vehicle. Once the air has passed through the battery case and/or over the battery module, the air is discharged at the rear end of the battery case through the outlet duct into the trunk of the vehicle.

### CROSS-REFERENCE TO RELATED APPLICATION

This application claims priority to and the benefit of Korean Patent Application No. 10-2010-0123051 filed in the Korean Intellectual Property Office on Dec. 03, 2010, the entire contents of which are incorporated herein by reference.

### BACKGROUND OF THE INVENTION

(a) Field of the Invention

The present invention relates to a high voltage battery cooling system for a vehicle. More particularly, the present invention relates to a high voltage battery cooling system for a vehicle cooling a high voltage battery.

(b) Description of the Related Art

Recently, interest in electric and hybrid vehicles has been greatly increasing due to their reduced emissions from fossil fuels. A hybrid vehicle is a vehicle that is driven by at least different two power sources that are efficiently combined. In most cases, it is a vehicle that is driven by both an electric motor using power of a battery and by an engine using fuel. This is called a hybrid electric vehicle (HEV). The necessary power for the electrical aspect of a hybrid electric vehicle is supplied by repeatedly charging/discharging a high-capacity, high voltage battery which supplies the driving electric power for an electric motor while traveling.

Alternatively, an electric vehicle is a vehicle that is driven by electric power only which is obtained from electrical energy rather than by burning any fossil fuel. The electric vehicle has a structure in which the vehicle is driven by rotating a motor which utilizes electric power accumulated in a battery.

Regardless of whether the vehicle is an HEV or an electric vehicle, it is necessary for the temperature of a high voltage battery in the vehicles to be maintained within a predetermined temperature range in order to provide optimized performance. For this, a conventional high voltage battery cooling system has a structure that cools a battery system mounted in a vehicle's interior trunk or within a lower portion of a back seat by drawing interior air of the vehicle near the back seat.

Unfortunately, however, battery systems can no longer be mounted in the vehicle trunk due to an increase in the size and quantity of batteries which are required by the current electric vehicles. Furthermore, when the battery system is mounted on the outside of the vehicle, it is difficult for the conventional cooling system structure to be equipped with an inlet structure and an outlet structure for cooling air and the interior distributing structure of the battery system. It is also difficult to cool to within an appropriate temperature range in order to maximize battery performance.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a high voltage battery cooling system for a vehicle having advantages of resolving problems due to an inlet structure and an outlet structure for cooling air, and an interior distribution structure of the battery system by mounting the high voltage battery system on an outer part of a vehicle, as well as cooling the battery in an appropriate temperature range in order to maximize battery performance.

An exemplary embodiment of the present invention provides a system for cooling a high voltage battery emitting cooling air from an outlet duct to the interior of a vehicle. More specifically, a battery case is mounted on an underfloor area formed at a lower part from a front seat to a back seat of the vehicle. An inlet duct is equipped at the front end of the battery case and draws the cooling air from the interior of the vehicle. Likewise, an outlet duct is equipped at the rear end of the battery case and discharges the cooling air that has passed a battery module.

The inlet duct may have a dual structure such that a part of cooling air flowing into the inlet duct enters the battery module and a part of the air enters a space between the battery module and an upper case. The passage of the cooling air flowing between the battery module and the upper case is controlled by a sealing member formed between the battery module and the upper case.

Furthermore, a connecting duct can be formed between the outlet duct and the battery module and a cooling fan can be formed between the connecting duct and the outlet duct. In addition, a duct protector can be formed between the outlet duct and the back seat. As stated above, the charging efficiency of the high voltage battery can be increased and the performance of the high voltage battery can be maximized by cooling the high voltage battery using the above described illustrative embodiment of the present invention.

### BRIEF DESCRIPTION OF THE DRAWINGS

FIG. 1 is a schematic diagram of a high voltage battery cooling system according to an exemplary embodiment of the present invention.

FIG. 2 is a partially detailed view of a structure of an inlet duct according to an exemplary embodiment of the present invention.

FIG. 3 is a cross-sectional view showing the flow of cooling air in which a sealing member is attached to a battery module.

FIG. 4 is a cross-sectional view of a cooling system for a high voltage battery including a connecting duct according to an exemplary embodiment of the present invention.

FIG. 5 is a cross-sectional view of an outlet duct and a trunk of a vehicle according to an exemplary embodiment of the present invention.

FIG. 6 is a partially detailed view of a structure without an inlet duct according to an exemplary embodiment of the present invention.

### DETAILED DESCRIPTION OF THE EMBODIMENTS

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

An exemplary embodiment of the present invention relates to a cooling system for cooling a battery module 33 mounted on an outer part of a vehicle, in particular, within an underfloor area 15.

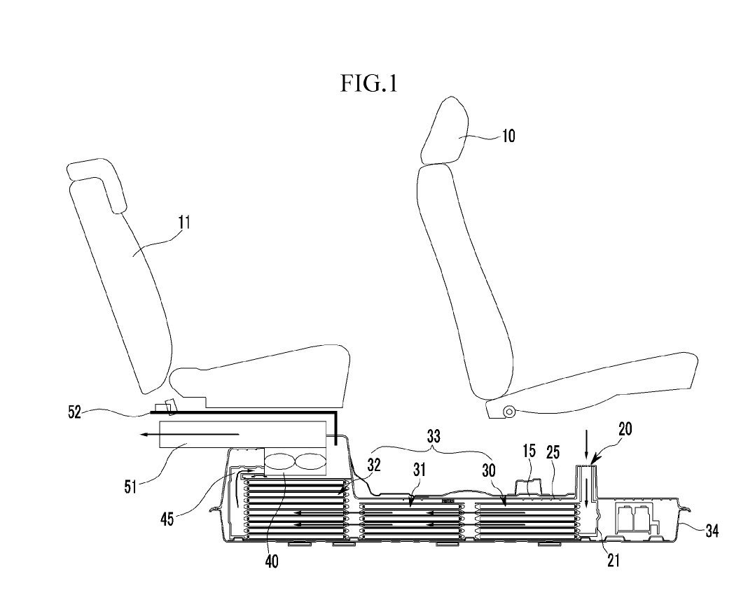

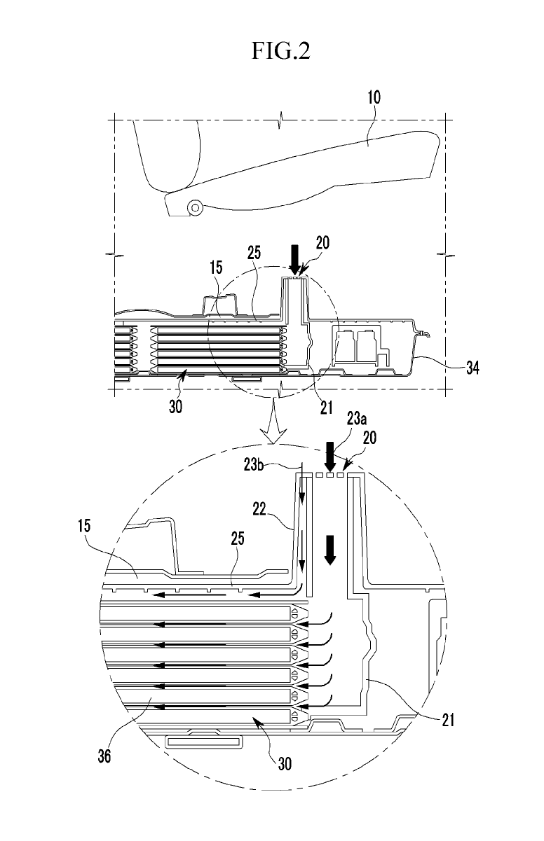

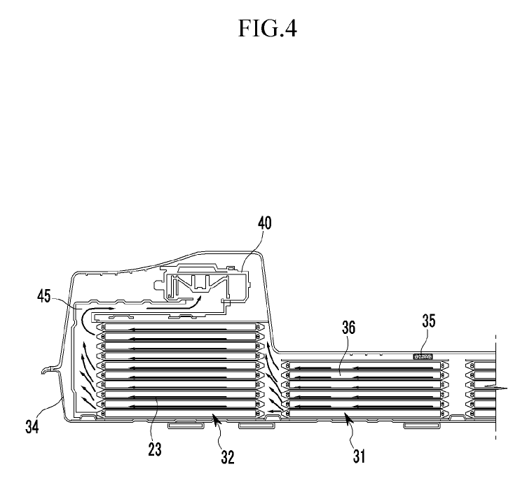

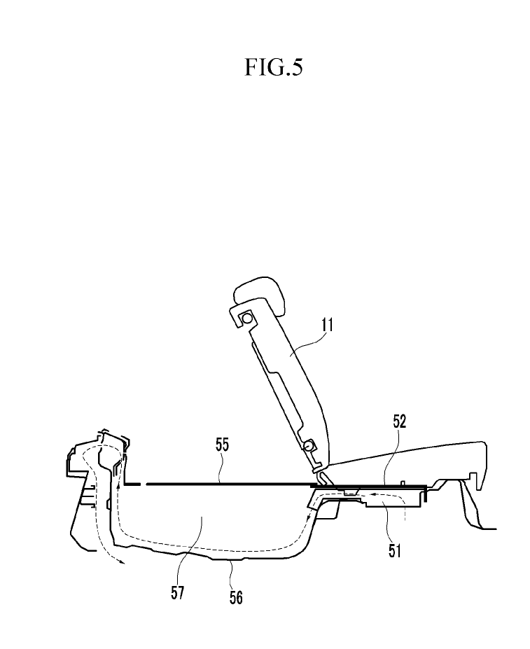

FIG. 1 is a schematic diagram of an entire high voltage battery cooling system according to an exemplary embodiment of the present invention, and FIG. 2 to FIG. 5 are partial schematic diagrams according to an exemplary embodiment of the present invention.

The high voltage battery cooling system according to an exemplary embodiment of the present invention includes a battery case 34 mounted on or within an underfloor area 15 formed at a lower part disposed between and from a front seat 10 and to a back seat 11, an inlet duct 20 equipped at the front end of the battery case 34 and connected/in fluid connection with the interior of the vehicle so that the inlet duct 20 draws in cooling air from the interior of the vehicle, and an outlet duct 51 equipped at the rear end of the battery case 34 discharges the cooling air having passed over the battery module 33.

The underfloor area 15 is formed at the lower part of the vehicle, and the inlet duct 20 has a dual structure that includes an inner pipe 21 for the cooling air flowing into the battery module 33 and an outer pipe 22 for the cooling air flowing between the battery module 33 and an upper case 25. That is, the inlet duct 21 has a dual structure so that a part of the inflowing cooling air enters into the battery module 33 and a part of the inflowing cooling air enters between the battery module 33 and the upper case 25. The passage of the cooling air entering between the battery module 33 and the upper case 25 can be controlled by a sealing member 35 formed between the battery module 33 and the upper case 25.

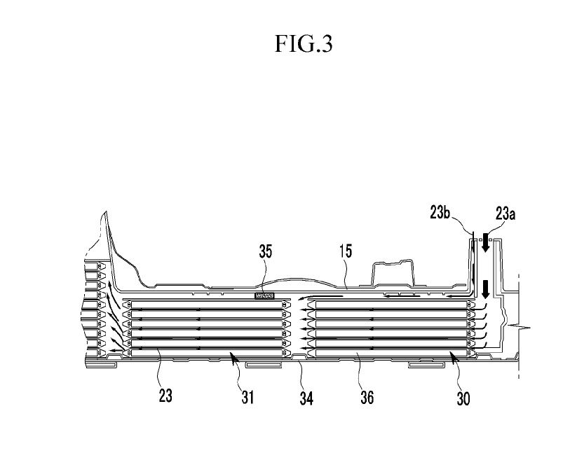

As illustrated in FIG. 3, cooling air 23a passing a front battery 30 and cooling air 23b passing through the inner pipe 21 and the outer pipe 22 are mixed so that a center battery 31 can be cooled efficiently.

As shown in FIG. 2, air in the inlet duct 20 flows into a battery cell 36 in the battery module 33, and the inlet duct 20 is formed so that the cooling air 23a cooling the battery module 33 and the cooling air 23b cooling the surface of the battery module 33 flowing between the battery module 33 and the upper case 25 can be separated.

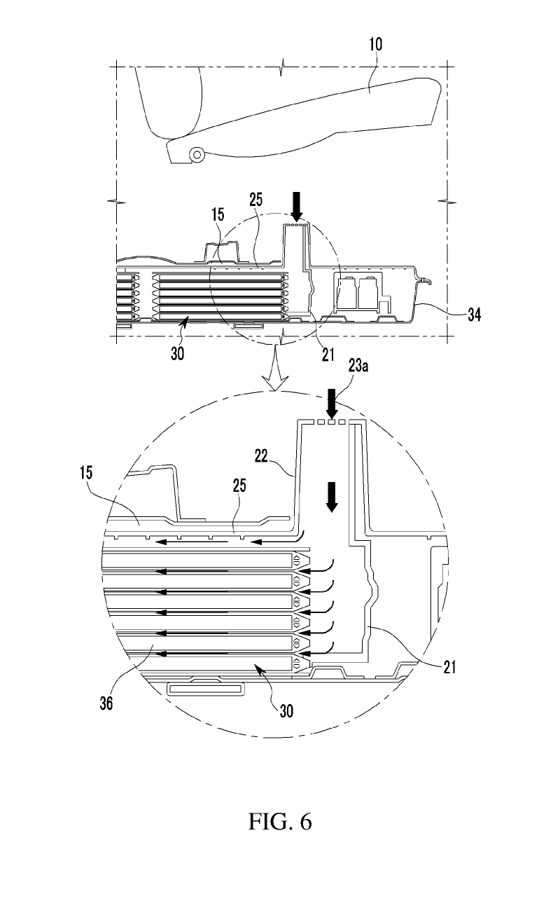

The cooling air introduced through the inlet duct 21 cools the battery while passing through the battery module 33 and the cooling air 23 cooling the battery module 33 is discharged into the interior of a trunk 57 through the outlet duct 51 and is then discharged to the outside. At this time, as shown in FIG. 6, the inlet duct 21 can be abbreviated. In this case, the battery case 34 is manufactured in order to function as the inlet duct 21.

The battery module 33 includes the front battery 30 disposed at the front end thereof, a rear battery 32 disposed at the rear end thereof, and the center battery 31 disposed at the center thereof. Also, a connecting duct 45 is formed between the outlet duct 51 and the battery module 33 so the outlet duct 51 is connected to a cooling fan 40.

The cooling fan 40 draws the cooling air through the battery case 34 and smoothly discharges it to the outside through the outlet duct 51. The connecting duct 45 can thus force the cooling air 23 in the battery module 33 to flow in a predetermined desired direction. The connecting duct 45 is formed in an “L” shape in an exemplary embodiment of the present invention. The high voltage battery cooling system according to an exemplary embodiment of the present invention can protect the outlet duct 51 with a duct protector 52 that is located between the outlet duct 51 and the back seat 11.

As described above, the cooling air discharging to the outside through the outlet duct 51 is discharged between a mat 55 inside the trunk 57 and a tire well 56, so as to be completely discharged.

Advantageously, the high voltage battery cooling system supplies the cooling air and can improve the performance of the battery module 33 by cooling it to an appropriate temperature without having to put the system in the trunk of the vehicle.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for cooling a high voltage battery by emitting cooling air from an outlet duct to the interior of a vehicle, comprising:
a battery case mounted on an underfloor area formed within a lower part extending from a front seat to a back seat; and
an inlet duct equipped at the front end of the battery case and drawing the cooling air from the interior of the vehicle, wherein the outlet duct is disposed at the rear end of the battery case and discharges cooling air that has passed over a battery module.

2. A system of claim 1, wherein the inlet duct has a dual structure such that a portion of cooling air flowing into the system enters the battery module and a portion of the air enters a space between the battery module and an upper case.

3. A system of claim 2, wherein the passage of the cooling air flowing between the battery module and the upper case is controlled by a sealing member formed between the battery module and the upper case.

4. A system of claim 1, wherein a connecting duct is formed between the outlet duct and the battery module.

5. A system of claim 4, wherein a cooling fan is formed between the connecting duct and the outlet duct.

6. A system of claim 1, wherein a duct protector is formed between the outlet duct and the back seat.

7. The system of claim 1, wherein the outlet duct discharges air into a trunk area of a vehicle.
